(19) United States
(12) Patent Application Publication
(10) Pub. No.: US 2020/0033863 A1
(43) Pub. Date: Jan. 30, 2020

(54) ADAPTATION OF AN EVALUABLE SCANNING AREA OF SENSORS AND ADAPTED EVALUATION OF SENSOR DATA

(71) Applicant: Robert Bosch GmbH, Stuttgart (DE)

(72) Inventors: Elmar Staudacher, Esslingen (DE); Udo Schulz, Vaihingen/Enz (DE)

(21) Appl. No.: 16/448,190

(22) Filed: Jun. 21, 2019

(30) Foreign Application Priority Data
Jul. 24, 2018 (DE) 102018212266.0

(51) Int. Cl. G05D 1/02; G06K 9/00; G06K 9/20

(52) U.S. Cl. CPC G05D 1/0214; G06K 9/00791; G06K 9/2054; G05D 1/0276; G05D 1/0259; G05D 1/0257; G05D 1/0255; G05D 1/0242; G05D 1/0231

(57) ABSTRACT

A method, in particular for a vehicle control, for adapting an evaluable scanning area of sensors and for evaluating sensor data as a function of a driving situation, a hazardous situation being detected by evaluating the sensor data with the aid of at least one control unit, the control unit being switched, due to the detection of the hazardous situation, into a hazard mode which differs from a normal mode, a scanning area of the sensors being reduced and/or the sensor data utilized for an evaluation being limited in the hazard mode with the aid of the control unit, and, based on the limited scanning area and/or the limited sensor data utilized for the evaluation, a trajectory is recalculated or a response is triggered by the control unit in order to avoid the hazardous situation.

### CROSS REFERENCE

The present application claims the benefit under 35 U.S.C. § 119 of German Patent Application No. DE 102018212266.0 filed on Jul. 24, 2018, which is expressly incorporated herein by reference in its entirety.

### FIELD

The present invention relates to a method, in particular for a vehicle control, for adapting an evaluable scanning area of sensors and for evaluating sensor data as a function of a driving situation. Moreover, the present invention relates to a system including at least one control unit and including at least one sensor, a computer program, and a machine-readable memory medium.

### BACKGROUND INFORMATION

Presently, the mobility sector is undergoing profound changes. In addition to a growing prevalence of electrically driven vehicles, automated driving is a relevant topic of future mobility.

The so-called SAE levels, which define the degree of automation, are known in the area of automated driving. The SAE levels define, from a level 0 to a level 5, whether a vehicle has no automation or is fully automated.

The vehicles presently in series production usually have a degree of automation up to level 1 or 2. These are usually vehicles including assisting systems, in which the driver mainly steers the vehicle. The first vehicles having a degree of automation according to level 3 are also known.

In a vehicle automated according to level 3, the driver may hand over the responsibility to the vehicle for a certain time duration. In an automation according to level 4 or 5, a driver is not even necessary at all in some driving scenarios; thus, the vehicle must be on the way without any fallback support.

The present-day vehicle systems utilize different input parameters and use the various data sources for carrying out a data fusion in order to obtain precise and reliable findings regarding the vehicle surroundings. Conventional methods for carrying out the data fusion usually cover requirements for assisted driving functions up to a degree of automation of level 3. A person is still responsible or functions as the fallback support. As soon as a person is no longer present, the system must be able to respond in a modified way.

PCT Application NO. WO 2013/138033 A1 describes a method and a device for actively modifying a field of view of an autonomous vehicle with respect to limitations. Objects or other limitations in the scanning area of the device may be detected and may be avoided by adapting the scanning area. Therefore, the object or the limitation may be “looked” past with the aid of the sensor system. Further related art is described in Europeant Patent Application No. EP 2 950 294 A1.

Conventional methods known behave the same way in hazardous situations and in normal situations. As a result, a response may not take place rapidly enough in hazardous situations in order to bypass or avoid a hazard.

### SUMMARY

An object of the present invention is to provide a method for rapidly carrying out system responses.

This object may be achieved in accordance with the present invention. Advantageous embodiments of the present invention are described herein.

According to one aspect of the present invention, a method is provided, in particular for a vehicle control, for adapting an evaluable scanning area of sensors and for evaluating sensor data as a function of a driving situation.

In one step, a hazardous situation is detected by evaluating the sensor data with the aid of at least one control unit. The hazardous situation may be, for example, a sudden brake application of a preceding vehicle, a person or an animal on a roadway of a vehicle, a tail end of a traffic jam, an accident, and the like.

Due to the detection of the hazardous situation, the control unit is switched into a hazard mode which differs from a normal mode.

In the activated hazard mode, a scanning area of the sensors is reduced with the aid of the control unit and/or the sensor data utilized for an evaluation are limited.

Based on the limited scanning area and/or the limited sensor data utilized for the evaluation, a trajectory is subsequently recalculated or a response is triggered by the control unit in order to avoid the hazardous situation.

According to one further aspect of the present invention, a system including at least one control unit and including at least one sensor is provided, the at least one control unit being coupleable to the at least one sensor in order to evaluate sensor data and the control unit being configured for carrying out all steps of the method according to the present invention.

Moreover, according to one aspect of the present invention, a computer program is provided, encompassing commands which, upon execution of the computer program by a computer or a control unit, prompt the computer or control unit to carry out the method according to the present invention, and a machine-readable memory medium is provided, on which the computer program according to the present invention is stored.

Fear has an important role in evolutionary history. In particular, the senses may be heightened by healthy fear, whereby a protection and survival mechanism is made possible, which may initiate an appropriate behavior in situations which are actually hazardous or are only perceived to be hazardous. For example, a heightened focus and an improved optical nerve and auditory nerve may result from fear. Moreover, the reaction speed is increased. Such a modified behavior or method may be necessary in various situations, in particular in hazardous situations.

With the aid of the method according to the present invention, the aspect of humanizing on the basis of healthy fear may be addressed. As a result of the detection of an emergency situation or a hazardous situation, a switch from a normal mode into a hazard mode may take place. Preferably, the hazard mode is designed for detecting the surroundings in an accelerated manner and for accelerating responses to a hazard. The particular modes may be stored in a control unit in a hardware-based and/or software-based manner.

The method according to the present invention is utilized, in particular, for departing from a static processing of the information from a sensor data fusion in an autonomous vehicle in favor of a dynamic and more humanized adaptation of the evaluation of the sensor data.

In this case, for example, the so-called field of view (FOV) of the sensors may be limited in a sensor-based or hardware-based manner. Moreover, on the basis of the sensor data, a portion of the sensor data corresponding to the limited scanning area may be utilized for the further evaluation. Due to such a reduction of the data volume, an accelerated evaluation and, therefore, a faster response to the hazard may be initiated by the control unit. As a result, a focus of the evaluation on a defined subarea of the scanning area of the sensors may take place, where the evaluation focuses on the hazardous surroundings. The selected subarea may be preferably learned or may be selected by the control unit depending on the situation.

Instead of a complete fusion of data from all available sensors, the sensor data from at least one relevant or best suited sensor may be utilized for the further evaluation and the execution of a response. In response to the hazardous situation, the activation of actuators, such as for carrying out steering motions, or for accelerating or decelerating the vehicle, may be initiated by the control unit. Alternatively or additionally, an adaptation of an existing trajectory, for example, in the form of an evasive trajectory, may be generated by the control unit.

As a result, the responsiveness of automatable vehicles may be accelerated. In particular, such a method is usable in vehicles which are designed according to a degree of automation higher than level 3 and, therefore, are operable without a driver.

According to one specific embodiment, in the hazard mode of the control unit, the scanning area of the sensors is reduced to a subarea by the control unit. As a result, a targeted limitation of the field of view may be carried out by one or multiple sensor(s) in order to focus only on a learned area in the hazardous surroundings. Therefore, a faster system response in the hazardous situation may be carried out due to an improved utilization of the available computing power.

According to one further specific embodiment, in the hazard mode of the control unit, the sensor data utilized for the evaluation are limited to the sensor data of at least one selectable sensor. Preferably, the sensor evaluation is limited to the sensor signal which is best suited in this hazardous situation for preferably rapidly initiating a system response in the hazardous situation. In particular, there is no wait until all sensor signals release the computed response to the control unit. The objective is to achieve a faster system response in the hazardous situation due to an improved utilization of the available computing power. The basis for these assumptions is that the other road users also have an obligation to proceed in traffic with caution and in an anticipatory manner.

A simplified model for the traffic flow may be assumed in order to carry out the method. Preferably, an abrupt change of the longitudinal dynamics does not take place, so that forceful braking is avoided and the traffic flow is maintained. Alternatively or additionally, it may be assumed that a defined error tolerance of other road users prevails, whereby the road users may respond on the basis of the actual traffic situation and, for example, dispense with rights of way in order to avoid accidents.

According to one further specific embodiment of the present invention, in the hazard mode of the control unit, an evaluation of sensor data of different sensors is carried out prioritized by the control unit. Therefore, the sensors, software, algorithms, and actuators necessary for a planned trajectory of the vehicle may be prioritized by the control unit in a sensor area selection or in a processing sequence as a function of the planned trajectory. As a result, a response time may be minimized while retaining the accuracy of the evaluation of the sensor data.

The sensor area selection may also encompass areas of the type which are usually not detected or perceived by a driver or an operator in conjunction with the situation. For example, in the event of a sudden evasive maneuver, a driver may forget to glance over his or her shoulder.

According to one further specific embodiment of the present invention, a limitation to the subarea of the scanning area and the selection of the at least one sensor in the hazard mode of the control unit are carried out based on a perception-response model of the control unit. The perception-response model may preferably encompass response patterns which are activated or preferably utilized in the hazard mode of the control unit. Therefore, dynamic behavior patterns may be provided, which are utilized in the hazard mode to ensure a rapid and focused response in order to avoid or prevent the hazard.

According to one further specific embodiment, the perception-response model is generated by the control unit and/or by at least one server unit, which is communicable with the control unit, on the basis of regional behavior patterns of road users. As a result, the perception-response model may be learned or programmed with consideration for behaviors of the road users, whereby a prediction of a response by nearby road users may be rapidly estimated by the control unit. The taking into account of information regarding regional and cultural behavior patterns of road users and surroundings conditions may be implemented by localization technologies and cloud/service provider connections. For example, the perception-response models of India and Germany are fundamentally different.

According to one further specific embodiment, the at least one sensor is designed as a camera, a radar sensor, a LIDAR sensor, an ultrasonic sensor, an infrared sensor, a magnetic field sensor, or a gas sensor. The method according to the present invention may therefore access a plurality of different sensors and utilize the sensors for calculating responses or evasive trajectories. In particular, the method for enabling a rapid response with the aid of a constricted and faster evaluation is not bound to certain technologies or fields of use. For example, the method may be utilized for passenger cars, commercial vehicles, public local and long-distance passenger transport, agricultural vehicles, and the like.

Preferred exemplary embodiments of the present invention are explained in greater detail below with reference to highly simplified schematic representations.

### BRIEF DESCRIPTION OF EXAMPLE EMBODIMENTS

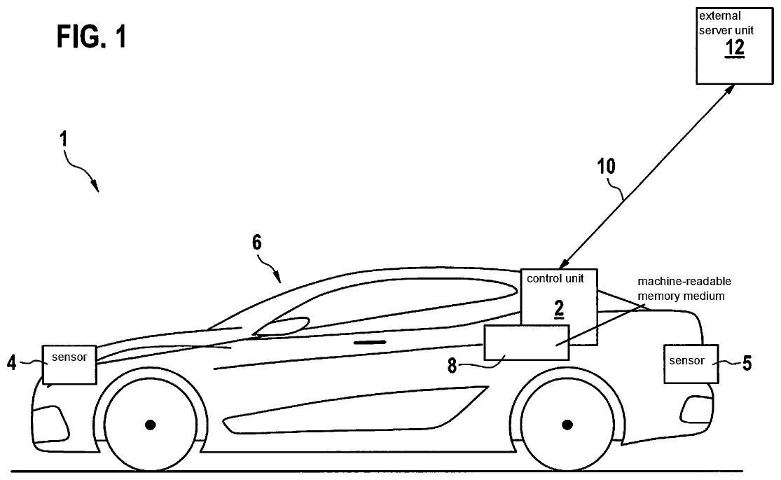

FIG. 1 shows a schematic representation of a sensor system according to the present invention.

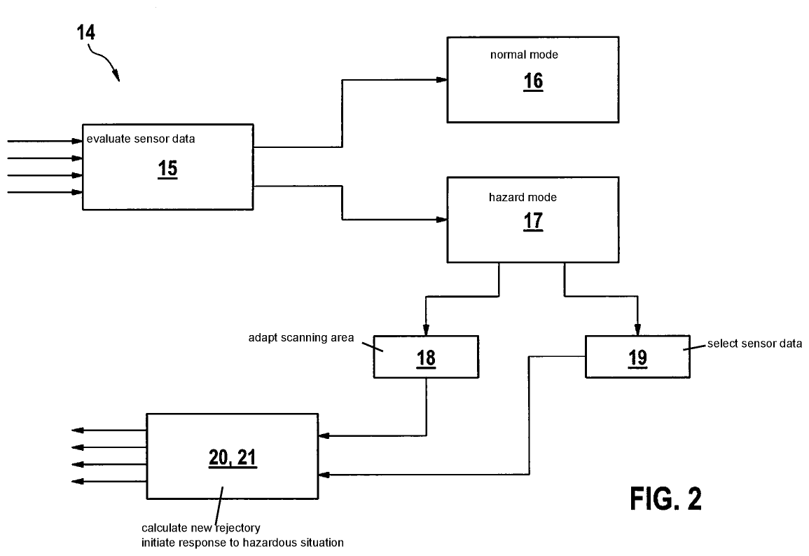

FIG. 2 shows a diagram for illustrating a method according to the present invention.

### DETAILED DESCRIPTION OF EXAMPLE EMBODIMENTS

A schematic representation of a system 1 including a control unit 2 and multiple sensors 4, 5 is shown in FIG. 1. System 1 is a component of a vehicle 6 which is designed as an autonomously operable passenger car according to SAE level 3.

According to the exemplary embodiment, a first sensor 4 is designed as a camera which is mounted on the front of a vehicle. A second sensor 5 is designed as a radar sensor for ascertaining distances and objects. Second sensor 5 is situated on the rear of the vehicle. The positions are to be understood to be examples and, in the exemplary application, may also be situated on the vehicle in another way.

Sensors 4, 5 are coupled to control unit 2. As a result, control unit 2 may evaluate the sensor data of sensors 4, 5 and control vehicle 6. Control unit 2 is connected to a machine-readable memory medium 8. Machine-readable memory medium 8 includes a computer program which encompasses commands which, upon the execution of the computer program by control unit 2, prompt control unit 2 to carry out a method according to the present invention.

Moreover, control unit 2 is designed for establishing a communication link 10 to an external server unit 12 and exchanging data therewith.

FIG. 2 shows a diagram for illustrating method 14 according to the present invention. In a step 15, sensor data of sensors 4, 5 are evaluated by control unit 2. In particular, in the first step, a check is carried out to determine whether an external hazardous situation exists or whether control unit 2 may act in a normal operating mode. Based on this evaluation 15, a normal mode 16 or a hazard mode 17 of control unit 2 may be activated. Sensor data ascertained by surroundings sensor systems 4, 5 are utilized as input parameters in this case.

If hazard mode 17 is activated, an adaptation of scanning area 18 of sensors 4, 5 takes place, on the one hand. In particular, the respective scanning area is reduced, whereby a smaller data volume is utilized for processing and the processing time by control unit 2 is reduced. The subarea to which the scanning area is reduced may depend on the situation. In particular, a subarea optimally adapted to a hazardous situation may be ascertained based on machine learning.

In parallel to the adaptation of scanning area 18, the sensor data of sensors 4, 5 are not utilized by control unit 2 based on a complete data fusion or sensor fusion. An adaptation or a selection 19 of the sensor data utilized for an evaluation by control unit 2 takes place. As a result, a data volume may be likewise reduced and the computation time may be increased.

Based on the limited scanning area and the limited sensor data, a new trajectory may be calculated 20 and a response 21 to the hazardous situation may be initiated by control unit 2. Response 21 and new trajectory 20 are utilized as output and are carried out by vehicle 6.

What is claimed is:

1. A method for a vehicle control for adapting an evaluable scanning area of sensors and for evaluating sensor data as a function of a driving situation, the method comprising:
detecting a hazardous situation by evaluating the sensor data with the aid of at least one control unit;
based on the detection of the hazardous situation, switching the control unit into a hazard mode which differs from a normal mode;
in the hazard mode, reducing a scanning area of the sensors with the aid of the control unit and/or limiting the sensor data utilized for an evaluation; and
based on the limited scanning area and/or the limited sensor data utilized for the evaluation, recalculating a trajectory or triggering a response by the control unit, to avoid the hazardous situation.

2. The method as recited in claim 1, wherein, in the hazard mode of the control unit, the scanning area of the sensors is reduced to a subarea by the control unit.

3. The method as recited in claim 1, wherein, in the hazard mode of the control unit, the sensor data utilized for the evaluation are limited to the sensor data of at least one selectable sensor.

4. The method as recited in claim 1, wherein, in the hazard mode of the control unit, an evaluation of sensor data of different sensors is carried out prioritized by the control unit.

5. The method as recited in claim 3, wherein the limitation to the subarea of the scanning area and a selection of the at least one selectable sensor is carried out in the hazard mode of the control unit based on a perception-response model of the control unit.

6. The method as recited in claim 5, wherein the perception-response model is generated by the control unit and/or by at least one server unit which is communicable with the control unit, based on regional behavior patterns of road users.

7. The method as recited in claim 3, wherein the at least one sensor is a camera, or a radar sensor, or a LIDAR sensor, or an ultrasonic sensor, or an infrared sensor, or a magnetic field sensor, or a gas sensor.

8. A system, comprising:
at least one control unit; and
at least one sensor;
wherein the at least one control unit is coupleable to the at least one sensor to evaluate sensor data, and the at least one control unit is configured to adapt an evaluable scanning area of sensors and for evaluating sensor data as a function of a driving situation, the control unit configured to:
detect a hazardous situation by evaluating the sensor data;
based on the detection of the hazardous situation, switch the control unit into a hazard mode which differs from a normal mode;
in the hazard mode, reduce a scanning area of the sensors with the aid of the control unit and/or limit the sensor data utilized for an evaluation; and
based on the limited scanning area and/or the limited sensor data utilized for the evaluation,
recalculate a trajectory or trigger a response by the control unit, to avoid the hazardous situation.

9. A non-transitory computer-readable storage medium on which is stored computer program including commands for adapting an evaluable scanning area of sensors and for evaluating sensor data as a function of a driving situation, wherein during execution of the computer program by a computer or a control unit, the computer program causing the computer or control unit to perform:
detecting a hazardous situation by evaluating the sensor data with the aid of at least one control unit;
based on the detection of the hazardous situation, switching the control unit into a hazard mode which differs from a normal mode;
in the hazard mode, reducing a scanning area of the sensors with the aid of the control unit and/or limiting the sensor data utilized for an evaluation; and
based on the limited scanning area and/or the limited sensor data utilized for the evaluation, recalculating a trajectory or triggering a response by the control unit, to avoid the hazardous situation.
